(19) United States
(12) Patent Application Publication
(10) Pub. No.: US 2011/0121537 A1
(43) Pub. Date: May 26, 2011

(54) Cap assembly threadless bicycle headset

(75) Inventor: Wen-Hwa Lin, Taichung City (TW)

(73) Assignee: VP Components Co., Ltd.

(21) Appl. No.: 12/592,443

(22) Filed: Nov. 24, 2009

(51) Int. Cl. B62K 21/02

(52) U.S. Cl. 280/279

(57) ABSTRACT

A cap assembly for a threadless bicycle headset is provided. The cap assembly includes a fastener and an outer cap integratedly combined with an exterior of the fastener. By the above structure, the integrated cap assembly has a simplified assembling process and improved stability over the prior art.

### BACKGROUND OF THE INVENTION

1. Technical Field

The present invention relates to headsets of bicycles, and more particularly, to a cap assembly for a headset of a bicycle. The cap assembly of the present invention combines a cap, a fastener and a seal ring of a conventional headset as an integrated assembly.

2. Description of Related Art

FIG. 1 depicts an upper bearing of a conventional headset. The upper bearing includes a cup 21, a ball retainer 221, a race 222, a fastener 23 and a cap 24. The cup 21 is coupled with an upper end of a head tube 93. The ball retainer 221 is set in the cup 21. The race 222 is deposited on the ball retainer 221. A steerer 90 passes inside the head tube 93. The fastener 23 is mounted around the steerer 90 and abuts upon an inner wall of the race 222. The cap 24 is mounted around the steerer 90 and, with the presence of an assembled stem 91, presses downward against the fastener 23 so that the fastener 23 firmly positions the race 222 and the ball retainer 221, and in turn makes the steerer 90 firmly held, thereby positioning the entire upper bearing and tubes. A rubber ring 25 is provided at an inner wall of the cap 24 for closely fitting with an outer wall of the steerer 90 as an oil seal.

To assemble the above upper bearing, at least the following steps have to be manually performed:

In the first step, placing the cup 21 on the upper end of the head tube 93;

In the second step, putting the ball retainer 221 in the cup 21;

In the third step, assembling the race 222 to the ball retainer 221;

In the fourth step, mounting the fastener 23 on the race 222;

In the fifth step, coupling the rubber ring 25 with the cap 24;

In the sixth step, covering the cap 24 on the fastener 23; and

In the seventh step, by fixing the stem 91, pressing the cap 24 downward to press against the fastener 23, so that the fastener 23 comes to position the race 222 and the ball retainer 221, thereby firmly holding the steerer 90.

From the above description, it is obvious that each of the individual components composing the conventional upper bearing requires an individual step to install it, causing the entire assembling process complex, labor-consuming and time-consuming.

### SUMMARY OF THE INVENTION

In view of the defects of the conventional upper bearing due to its numerous components, the present invention herein provides an integrated cap assembly.

One objective of the present invention is to provide a cap assembly for a threadless bicycle headset, wherein the cap assembly helps to reduce the number of components in an upper bearing, thereby simplifying and abridging the assembling process, while the stability of the resultant structure can be also improved.

The cap assembly of the present invention primarily includes a fastener and an outer cap that is made of a rubber material and integratedly combined with an exterior of the fastener.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 depicts a conventional upper bearing for a bicycle headset;

FIG. 2 is a perspective view of a cap assembly of the present invention taken from a first visual angle;

FIG. 3 is another perspective view of the cap assembly of the present invention taken from a second visual angle;

FIG. 4 is a cross-section view of the cap assembly of the present invention;

FIG. 5 is a schematic view illustrating the cap assembly of the present invention assembled to a bicycle headset; and

FIG. 6 is a cross-sectional view of the disclosed cap and the bicycle headset assembled together.

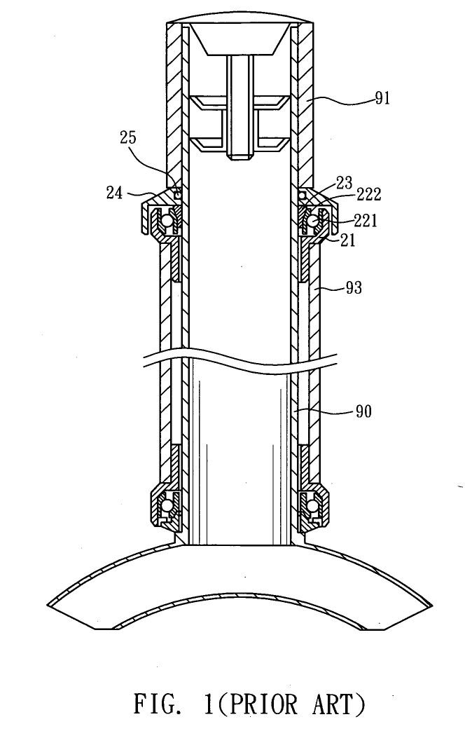

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale. Besides, like numerals are used throughout this description to describe similar or identical parts, unless otherwise indicated.

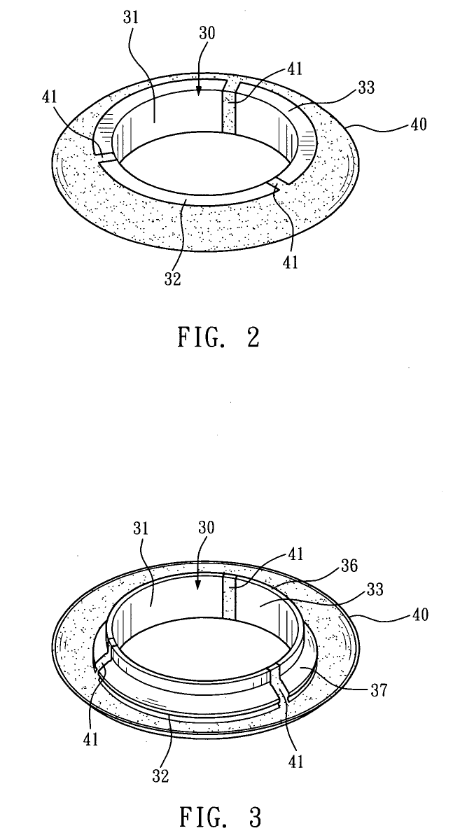

Referring to FIGS. 2 and 3, a cap assembly of the present invention includes a fastener 30 and an outer cap 40 integratedly combined with an exterior of the fastener 30.

The fastener 30 is composed of a plurality of separate fastening petals 31, 32, 33 arranged as a circle. The outer cap 40 is molded with a rubber material and connects with upper curved edges of the fastening petals 31, 32, 33. The outer cap 40 further has a plurality of connecting ribs 41 protruding centripetally, and each of the connecting ribs 41 is configured to be flanked by two adjacent said fastening petals 31, 32, 33, so as to associate the separate fastening petals 31, 32, 33.

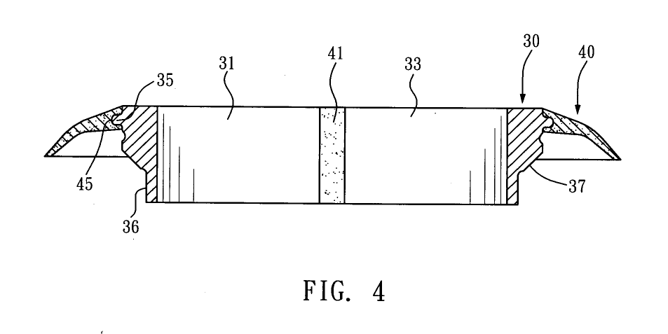

As shown in FIGS. 3 and 4, the outer cap 40 and the fastener 30 may be provided at borders therebetween with a retaining groove 45 and a flange 35 that are configured to engage with each other, so as to ensure the combination between the outer cap 40 and the fastener 30, and provide a watertight function. The fastener 30 has a fastening segment 36 extending axially downward from a bottom of the outer cap 40. A sloping lower pressing surface 37 is formed at an outer wall of the fastening segment 36.

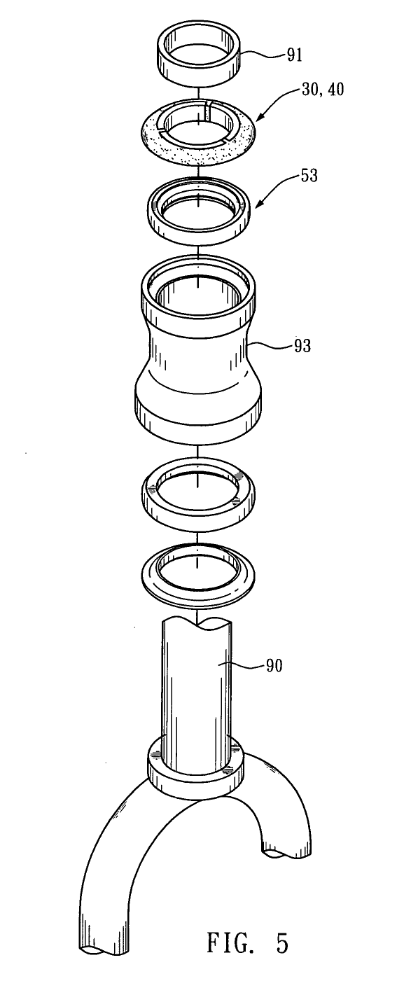

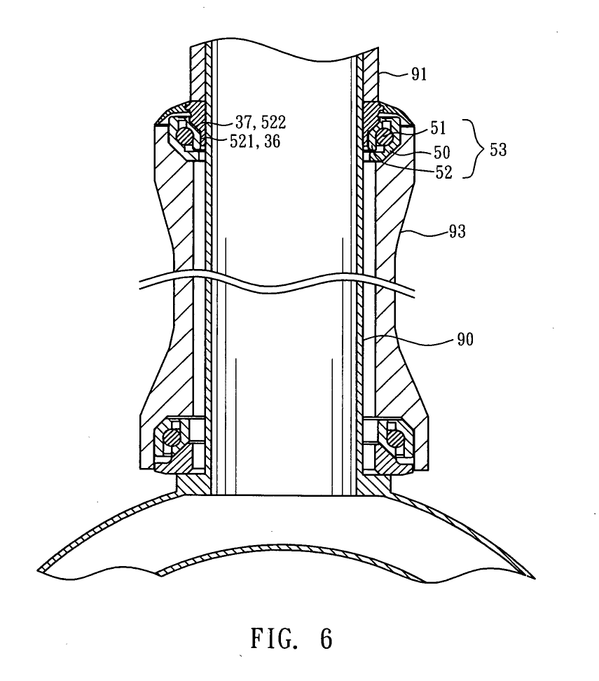

FIGS. 5 and 6 show the cap assembly of the present invention assembled with a bicycle upper bearing. The upper bearing includes the conventional cup 50, ball retainer 51 and race 52. In the present embodiment, the cup 50, ball retainer 51 and race 52 are pre-fabricated as a bearing unit 53. The bearing unit 53 is mounted on an upper end of a bicycle head tube 93 that further receives a steerer 90 passing therein. The cap assembly of the present invention is then mounted around the steerer 90 to be set on the race 52 of the bearing unit 53. An outer surface of the fastening segment 36 thus comes into contact with a vertical inner periphery 521 of the race 52, while the sloping lower pressing surface 37 comes into contact with an upper pressing surface 522 of the race 52 sloping complementarily. The outer cap 40 thus covers over the entire top of the cup 50. A stem 91 then sleeves an upper portion of the steerer 90 and presses downward to retain the cap assembly, so that the cap assembly firmly positions the bearing unit 53 and thereby holds the steerer 90 tight.

The assembling process of an upper bearing with the disclosed the cap assembly undergoes the following steps:

In the first step, assembling the bearing unit 53 with the upper end of the head tube 93;

In the second step, mounting the cap assembly on the bearing unit 53; and

In the third step, by fixing the stem 91, pressing the cap assembly downward, so as to make the fastener 30 firmly position the race 52 and the ball retainer 51, thereby holding the steerer 90 tight.

Thus, as compared with the conventional upper bearing, the present invention reduces four assembling steps in the assembling process. By simplifying the components in the upper bearing, the cap assembly of the present invention substantially lessens the assembling work of the novel upper bearing, thus realizing a more convenient, economic and rapid assembling process.

When the cap assembly of the present invention is positioned by the stem 91, the contacting upper pressing surface 522 of the race 52 and the lower pressing surface 37 of the fastener 30 jointly force the fastening petals 31, 32, 33 of the fastener 30 to converge centripetally, and to compress the rubber connecting ribs 41 positioned therebetween. Since the connecting ribs 41 are flanked by two adjacent said fastening petals 31, 32, 33, they are spaced equidistantly along the circular periphery of the fastener 30. At this time, the connecting ribs 41 and the outer cap 40, both made of the rubber material, ensure the fastening petals 31, 32, 33 to equally move when they converge centripetally, so that the fastener 30 can generate a centripetal compressing force to not only hold the steerer 90 tight but also make the steerer 90 positioned centrally.

Briefly, the cap assembly of the present invention combines the fastener, the cap, and the seal ring in the cap of the conventional upper bearing into a pre-fabricated integrated assembly. Thereby, a single assembling step can position the seal ring, the fastener and the cap at the same time, and achieve the multiple functions of fastening the steerer, centralizing the steerer, posing the upper bearing watertight and dustproof, positioning the ball retainer as well as the race, and improving the stability of the overall structure.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A cap assembly for a threadless bicycle headset, the cap assembly comprising:
a fastener; and
an outer cap integratedly combined with an exterior of the fastener.

2. The cap assembly as claimed in claim 1, wherein the fastener comprises at least two fastening petals that are separate from each other by a predetermined distance and circularly arranged along an inner wall of the outer cap.

3. The cap assembly as claimed in claim 2, wherein the outer cap is integrally formed by a rubber material.

4. The cap assembly as claimed in claim 3, wherein the outer cap further has a plurality of connecting ribs protruding centripetally, and each of the connecting ribs is configured to associate two adjacent said fastening petals.

5. The cap assembly as claimed in claim 1, wherein the outer cap and the fastener are provided at borders therebetween with a retaining groove and a flange that are configured to engage with each other.

6. The cap assembly as claimed in claim 1, wherein the fastener has a fastening segment extending axially downward from a bottom of the outer cap.

7. The cap assembly as claimed in claim 6, wherein the fastening segment has a sloping lower pressing surface.
